(19) United States
(12) Patent Application Publication
(10) Pub. No.: US 2026/0102849 A1
(43) Pub. Date: Apr. 16, 2026

(54) SYSTEMS AND METHODS FOR REGULATING FLUID FLOWS IN LASER PROCESSING SYSTEMS

(71) Applicant: Hypertherm, Inc., Hanover, NH (US)

(72) Inventors: Marco Celeghin, Venice (IT); Kenneth J. Woods, New London, NH (US); Joe Ciambra, Thetford Center, VT (US); David J. Cook, Bradford, VT (US)

(21) Appl. No.: 19/259,126

(22) Filed: Jul. 3, 2025

Related U.S. Application Data
(60) Provisional application No. 63/667,219, filed on Jul. 3, 2024.

(51) Int. Cl. B23K 26/14; B23K 26/12

(52) U.S. Cl. CPC B23K 26/1476; B23K 26/125

(57) ABSTRACT

A nozzle for a laser processing head is provided. The nozzle comprises a body defining a bore extending between a proximal region of the body and a distal region of the body. The bore is configured to conduct a laser beam along with a first portion of a fluid therethrough for delivery to a workpiece. The nozzle also includes a cap coupled to the distal region of the body and a plurality of secondary passages cooperatively defined between the cap and the body and disposed circumferentially about the bore of the body. The plurality of secondary passages are configured to conduct a second portion of the fluid through the distal region and circumferentially about the bore. A flow rate of the second fluid portion through the plurality of secondary passages is slower than a flow rate of the first fluid portion through the bore.

### CROSS REFERENCE TO RELATED APPLICATION

This application claims the benefit of and priority to U.S. Provisional Patent Application No. 63/667,219 filed on Jul. 3, 2024, the entire content of which is owned by the assignee of the instant application and incorporated herein by reference in its entirety.

### TECHNICAL FIELD

The present invention generally relates to systems and methods for regulating fluid flows through a multi-piece nozzle of a laser processing system.

### BACKGROUND

Material processing systems, including laser processing systems, liquid jet processing systems and plasma arc torch systems, are widely used for processing (e.g., heating, cutting, gouging and marking) of materials, such as metal sheets. A laser processing system generally includes a high-power laser, a pressurized gas stream, an optical system, and a computer numerical control system (CNC). In operation, laser processing systems use the gas stream to blow molten material away from a workpiece while controllably delivering the laser beam to the workpiece to process the workpiece. Laser processing systems are frequently used in precision cutting operations due to the ease of control provided by the laser beam, gas stream, and geometry of the laser nozzles.

When using the gas stream to blow molten material way from the workpiece during a laser processing operation, the flow profile of the gas stream is determined by the operating pressure and physical characteristics of the nozzle geometry. Traditionally, the gas stream comprises air, oxygen, nitrogen, argon, etc. or mixtures of these various gases. The selected gas chemistry and workpiece material tend to have a significant impact on cutting performance and results.

Recently, high-power fiber lasers are used to cut thick mild steel workpieces instead of conventional laser systems. These high-power fiber lasers typically use oxygen as the fluid to generate the pressurized gas stream where the laser beam is approximately the same size as the nozzle orifice. When cutting thick mild steel workpieces with these high-power fiber lasers, entrainment of nitrogen into the kerf significantly degrades the quality of the cutting result/product. To combat this issue, the laser nozzle is traditionally maintained close to the workpiece (e.g., typically a 0.3-0.5 mm standoff distance) to avoid entrainments of the nitrogen portion of the air, primarily ambient and air-cooling circuit interference, into the cutting kerf. However, any small variation in the standoff distance can cause poor cut quality. In addition, such a low standoff distance (and thus proximity) between the laser nozzle and the workpiece during an operation can easily expose the laser processing head to collisions as well as increased thermal loads and debris.

These quality considerations are complicated by design constraints in typical laser processing systems, where the diameter of the laser beam is approximately the same as the diameter of the nozzle orifice. In addition, to generate good cut quality and nozzle life, the operating window (e.g., design space or flexibility for adjusting dimensions) for the beam focus and nozzle size is quite narrow.

Therefore, there is a need for apparatuses and methods that can minimize nitrogen entrainment during laser cutting to improve cut quality while increasing standoff distance between the laser nozzle and workpiece to reduce collisions, all of which can accommodate the tight design constraints on laser nozzles.

### SUMMARY

The present invention features a laser nozzle of a laser processing system, where the laser nozzle has a set of one or more secondary paths of a secondary fluid (e.g., a secondary cutting gas) with a relatively low flow rate. For example, the flow rate of the secondary fluid through the set of one or more secondary paths is lower than the flow rate of the primary fluid flow exiting from the main orifice with the laser beam, such as between about 20% and about 80% the flow rate of the primary fluid. In some embodiments, a nozzle tip cap is disposed at the distal tip of the main nozzle body and is shaped to complement features of the nozzle body to create the set of one or more secondary paths for the secondary fluid.

In one aspect, the present invention features a nozzle for a laser processing head that comprises a body, a cap and a plurality of secondary passages. The body defines a bore extending between a proximal region of the body and a distal region of the body. The bore is configured to conduct a laser beam along with a first portion of a fluid therethrough for delivery to a workpiece. The cap is coupled to the distal region of the body. The plurality of secondary passages are cooperatively defined between the cap and the body and disposed circumferentially about the bore of the body. The plurality of secondary passages are configured to conduct a second portion of the fluid through the distal region and circumferentially about the bore. A flow rate of the second fluid portion through the plurality of secondary passages is slower than a flow rate of the first fluid portion through the bore.

In another aspect, the present invention features a method for processing a workpiece with a laser cutting system comprising a nozzle. The method includes flowing a cutting gas from a gas source into the nozzle, dividing the cutting gas into a primary cutting gas and a secondary cutting gas within the nozzle, and dispelling the primary cutting gas from a central bore of the nozzle via an outlet of the bore located at a distal face of the nozzle. The method also includes exhausting the secondary cutting gas from the distal face of the nozzle in a circumferential pattern about the outlet of the bore substantially enshrouding the primary cutting gas.

Any of the above aspects can include one or more of the following features. In some embodiments, the plurality of secondary passages includes corresponding ones of a plurality of outlets that are substantially evenly spaced circumferentially about the bore in the distal region. In some embodiments, each of the plurality of outlets has a non-circular cross-sectional shape. The non-circular cross-sectional shape can comprise one of arcuate, square, or polygonal. In some embodiments, the plurality of outlets includes at least four outlets.

In some embodiments, the body of the nozzle includes a protrusion extending from a distal face of the body in the distal region. The protrusion includes a distal portion of the bore, and the protrusion is adapted to extend through the cap along a central longitudinal axis of the cap upon the cap being coupled to the body. In some embodiments, the nozzle includes a plurality of press fit features formed on a circumferential surface of the protrusion. The plurality of press fit features is shaped to engage and align the cap upon the cap being coupled to the body.

In some embodiments, the cap has an axial length of about 25% of an axial length of the body. In some embodiments, a distal end face of the body has a width of about 50% of a width of a distal end face of the cap. In some embodiments, the axial length of the cap is between about 7 mm and about 9 mm. In some embodiments, the cap is made of brass or stainless steel. In some embodiments, the body and the cap are made from different materials.

In some embodiments, the first fluid portion through the bore is utilized as a primary cutting gas and the second fluid portion through the plurality of secondary passages is utilized as a secondary cutting gas. In some embodiments, the secondary cutting gas has a flow rate of less than about 50% that a flow rate of the primary cutting gas.

In some embodiments, the bore has a cross-sectional area of between about 1.1 mm² and about 3.1 mm² and the plurality of secondary passages has a combined cross-sectional area of between about 0.7 mm² and about 1.5 mm². In some embodiments, a ratio of the cross-sectional area of the bore to the cross-sectional area of the plurality of secondary passages is between about 1.1 and about 4.4.

In some embodiments, the nozzle further comprises a plurality of tertiary passages cooperatively defined between the body and the cap and located circumferentially outward from the bore and the plurality of secondary passages. The plurality of tertiary passages is configured to direct a coolant flow therethrough. In some embodiments, the coolant flow is a coolant gas. In some embodiments, the plurality of tertiary passages is configured to direct the coolant flow axially away from the workpiece. In some embodiments, the coolant flow is exhausted from a circumferential surface of the nozzle away from the outlet of the bore for expelling the primary cutting gas.

In some embodiments, the nozzle further comprises a plurality of sealing features formed on a proximal surface of the cap and a distal surface of the body proximate the bore. In some embodiments, the plurality of sealing features are deformable metal seals. In some embodiments, the nozzle further comprises a plurality of crimping features formed proximate a circumferential edge of at least one of the cap or the body for matingly engaging the cap to the body.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows a cross-sectional view of an exemplary nozzle of a laser processing head, according to some embodiments of the present invention.

FIG. 2 shows a distal perspective view of the laser nozzle of FIG. 1, according to some embodiments of the present invention.

FIG. 3 shows an exemplary schematic array of the outlets of the set of secondary passages of the laser nozzle of FIG. 2, according to some embodiments of the present invention.

FIG. 4 shows a perspective view of the body of the laser nozzle of FIG. 1 to illustrate the portion of the tertiary passages located in the body of the laser nozzle 100, according to some embodiments of the present invention.

FIG. 5 shows another perspective view of the body of the laser nozzle of FIG. 1 to illustrate some of the alignment and engagement features of the body, according to some embodiments of the present invention.

FIG. 6 shows a portion of the laser nozzle of FIG. 1 to highlight the alignment and engagement features of FIG. 5, according to some embodiments of the present invention.

FIG. 7 shows a cross-sectional side view of the laser nozzle of FIG. 1 to illustrate exemplary dimensions of various components of the nozzle, according to some embodiments of the present invention.

FIG. 8 shows an exemplary process for cutting a workpiece with a laser cutting system comprising the laser nozzle of FIG. 1, according to some embodiments of the present invention.

### DETAILED DESCRIPTION

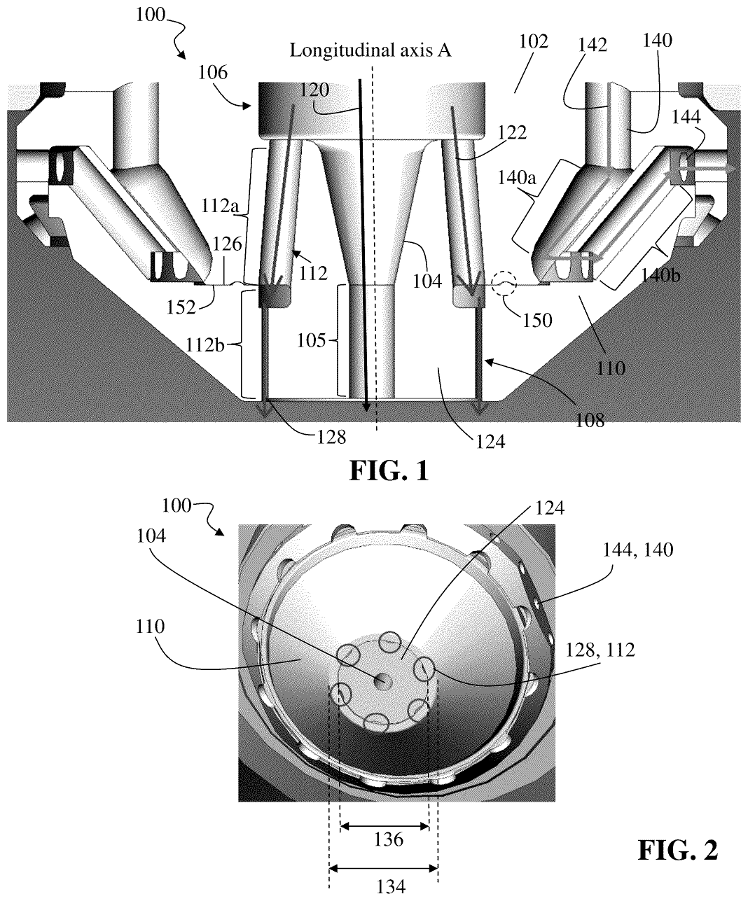

FIG. 1 shows a cross-sectional view of an exemplary nozzle 100 of a laser processing head, according to some embodiments of the present invention. As shown, the nozzle 100 generally includes a main body 102 defining a central bore 104 extending between a proximal region 106 and a distal region 108 of the body 102 along a central longitudinal axis A. The distal region 108 is defined as the region/end of the nozzle 100 that is closest to a workpiece (not shown) when the nozzle 100 is processing the workpiece and the proximal region 106 is defined as the region/end that is opposite of the distal region 108 along the central longitudinal axis A. The central bore 104 is configured to conduct a laser beam along with a portion 120 of a cutting fluid therethrough for delivery to the workpiece. In some embodiments, the nozzle body 102 includes a protrusion portion 124 extending axially from a distal end face 126 of the body 102 in the distal region 108. The protrusion portion 124 of the body 102 includes (e.g., defines) a distal portion 105 of the bore 104 embedded therein. The nozzle 100 also includes a cap 110 coupled to and matingly engaged with the distal region 108 of the body 102, such as disposed substantially circumferentially about the distal region 108 of the body 102. In some embodiments, upon the cap 110 being coupled to the body 102, the protrusion portion 124 of the body 102 extends axially forward (along the central longitudinal axis A) through a central opening of the cap 110.

In some embodiments, the protrusion portion 124 of the body 102 and the cap 110 are suitably dimensioned to define at least a portion of a set of secondary passages 112 therebetween. As shown in FIG. 1, the set of one or more secondary/auxiliary passages 112 are circumferentially disposed about the central bore 104. While upper sections 112a of the secondary passages 112 are defined by apertures/holes within the nozzle body 102, lower sections 112b of the secondary passages 112 are cooperatively formed between external circumferential surfaces of the protrusion portion 124 of the body 102 and internal surfaces surrounding the opening of the cap 110. In some embodiments, the secondary passages 112 include corresponding ones of outlets 128 that are substantially evenly spaced circumferentially about the central bore 104 in the distal region 108. These outlets 128 are also cooperatively defined between the protrusion portion 124 of the body 102 and the cap 110. In some embodiments, the set of secondary passages 112 are configured to conduct a second portion 122 of the same cutting fluid (provided through the central bore 104) to the distal region 108 and circumferentially about the bore 104. The second fluid portion 122 is adapted to exit via the outlets 128 substantially shrouding the first fluid portion 120 that exits through the bore 104. In some embodiments, the cutting fluid supplied to the nozzle 100 is a cutting gas, the first portion 120 of the cutting gas conducted through the bore 104 serves as a primary cutting gas, and the second portion 122 of the cutting gas conducted through the secondary passages 112 serves as an auxiliary/secondary cutting gas.

FIG. 2 shows a distal perspective view of the laser nozzle 100 of FIG. 1, according to some embodiments of the present invention. As shown, the interface between the cap 110 and the protrusion portion 124 of the body 102 from the distal perspective is substantially circumferential and forms a barrier for preventing axial fluid flow (along the longitudinal axis A) except through the multiple outlets 128 of the secondary passages 112 that are disposed circumferentially about the central bore 104. The secondary passage outlets 128 are shaped to expel the secondary cutting gas 122 to substantially enshroud the primary cutting gas 120 and laser beam as they emerge from the central bore 104. In some embodiments, the secondary cutting gas 122 is vented from the secondary passages 112 to atmosphere about the primary cutting gas flow 120 of the central bore 104. In some embodiments, each of the outlets 128 of the secondary passages 112 has a non-circular cross-sectional shape, such as arcuate, square, or polygonal. For example, the outlets 128 illustrated in FIG. 2 have semi-arcuate shapes. Even though FIG. 2 illustrates the set of secondary passages 112 comprising six secondary passages 112, there can be more or fewer secondary passages 112, such as four secondary passages 112 with their respective outlet 128 dispersed circumferentially around the bore 104.

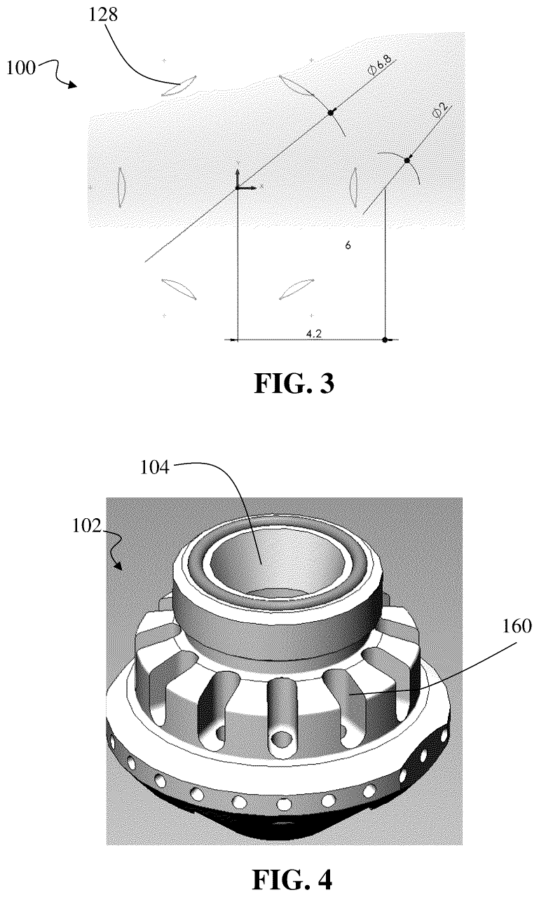

FIG. 3 shows an exemplary schematic array of the outlets 128 of the set of secondary passages 112 of the laser nozzle 100 of FIG. 2, according to some embodiments of the present invention. The array demonstrates the cross-sectional shape and size/proportion of the outlets 128. As shown, each of the outlets 128 have a substantially arcuate shape. In addition, a cumulative cross-sectional area of all the outlets 128 is substantially less than the cross-sectional area of the narrowest part of the central bore 104. In some embodiments, the narrowest part of the central bore 104 has a cross-sectional area of between about 1.1 mm² and about 1.6 mm², and the cumulative cross-sectional area of all the secondary passages 112 combined is between about 0.7 mm² and about 1.0 mm². In one example, the bore 104 has a diameter of about 1.4 mm, which creates a cross-sectional bore area of about 1.54 mm². In another example, the bore 104 has a diameter of about 1.2 mm, which creates a cross-sectional bore area of about 1.13 mm². In either case, the cumulative cross-sectional area of the six outlets 128 can be about 0.87 mm², which is significantly less than the cross-sectional area of the narrowest part of the bore 104. In some embodiments, the cross-sectional area of the bore 104 is between about 1.2 and about 2 times the total of the cross-sectional areas of the outlets 128. Due to the smaller cumulative cross-sectional area of the secondary passages 112 in comparison to that of the bore, the flow rate of the second fluid portion 122 through the secondary passages 112 is slower than the flow rate of the first fluid portion 120 through the central bore 104.

Referring to FIG. 1, in some embodiments, the nozzle 100 further includes a set of one or more tertiary passages 140 cooperatively defined between the body 102 and the cap 110. These tertiary passages 140 can be located circumferentially outward from the bore 104 and the set of secondary passages 112. In some embodiments, the set of tertiary passages 140 are configured to direct a coolant flow 142 (e.g., a cooling gas) therethrough for cooling the nozzle 100. As shown, the set of tertiary passages 140 includes (i) features 140a extending through the body 102 configured to, in collaboration with the cap 110, direct the coolant flow 142 axially forward toward the distal region 108 and (ii) features 140b extending through the cap 110 configured to redirect the coolant flow 142 axially backward toward the proximal region 106. The coolant flow 142 is then exhausted out of the nozzle 100 to atmosphere via a set of outlets 144 corresponding to respective ones of the tertiary passages 140. The set of outlets 144 can be formed in the cap 110 and/or the body 102. The set of tertiary passages 140 allows the coolant flow 142 to be exhausted away from the primary cutting gas flow 120 through the central bore 104 (and away from the workpiece) to avoid impacting the cutting process while still cooling various components of the laser body 102 and the laser cap 110 proximate the distal region 108. The cooled components include the primary cutting gas 120 and the central bore 104 along with the auxiliary cutting gas 122 and the set of secondary passages 112. Thus, the cap 110 has the additional function of creating in part a coolant flow circuit with the outlets 144 away from the cutting process. In some embodiments, coolant flow 142 includes a fluid of a different chemistry (e.g., a different type of gas, a mixture of gases, a liquid, etc.) than that of the primary cutting gas 120.

FIG. 4 shows a perspective view of the body 102 of the laser nozzle 100 of FIG. 1 to illustrate certain features 160 of the tertiary passages 140 located in the body 102 of the laser nozzle 100, according to some embodiments of the present invention. As shown, the features 160 of the tertiary passages 140 in the main body 102 comprise a set of grooves circumferentially dispersed around the bore 104 to receive a gas flow (e.g., the coolant flow 142) from the laser processing head. In some embodiments, the grooves 160 are proximal to and in fluid communication with grooves 140a of the tertiary passages 140 to direct the coolant flow 142 axially forward toward the distal region 108. One advantage of such a configuration is that there is no need to clock any complementary features of the cap 110 with the grooves to form the forward-extending channels of the tertiary passages 140, thereby enabling ease of assembly (i.e., clockless engagement) between the body 102 and the cap 110. Therefore, the body 102 defines not only the central bore 102 for conducting a laser beam along with a primary cutting fluid 120, but also portions of the secondary passages 112 for conducting a secondary cutting fluid 122, as well as certain features 140a, 160 of the tertiary passages 140 for conducting a coolant flow 142.

Referring back to FIG. 1, the features 140b of the cap 110 for forming the tertiary passages 140 include the interior surfaces that define the forward-extending channels of the tertiary passages 140 when combined with the body 102 (and features 140a of the body 102). These features 140b also include a set of rearward-extending channels of the tertiary passages 140 that is configured to receive the coolant flow 142 from the forward-extending channels and guide the coolant flow 142 toward the proximal region 106 of the body 102. The features 140b can further include outlets 144 that are configured to exhaust the coolant flow 142 in the rearward-extending channels to atmosphere.

In some embodiments, the nozzle 100 further includes a sealing feature 150 located between the body 102 and the cap 110, such as along the distal end face 126 of the body 102 and a proximal face 152 of the cap 110 proximate the bore 104, as shown in FIG. 1. The sealing feature 150 is configured to fluidly separate the primary cutting 120 in the bore 104 and/or the secondary cutting gas 122 in the secondary passages 112 from the coolant flow 142 in the tertiary passages 140. In some embodiments, the sealing feature 150 includes a raised ridge formed on the proximal surface 152 of the cap 110 and shaped to matingly/sealingly engage a complementary feature (e.g., a concave surface) on the body 102 to shield the auxiliary cutting gas flow 122 and the primary cutting gas flow 120 from contamination and/or influence of the coolant flow 142. In some embodiments, the sealing feature 150 is a deformable seal, such as a deformable metal seal that provides a metal-to-metal seal with the body 102. In some embodiments, the sealing feature 150 also provides alignment and spacing between the cap 110 and the body 102 during manufacture, assembly, and/or operation.

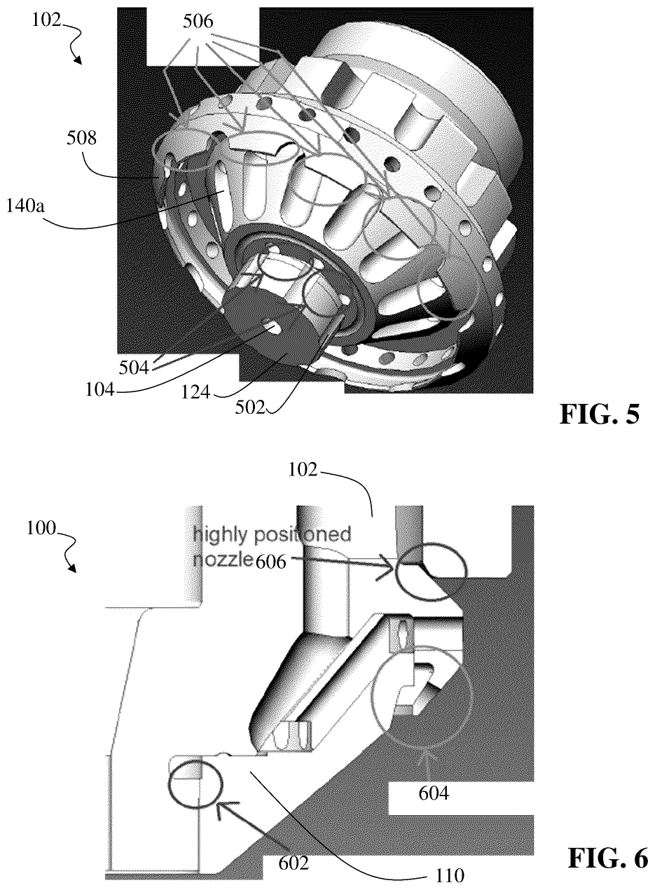

In some embodiments, the nozzle 100 further includes one or more alignment and engagement features distributed between the body 102 and the cap 110 to properly orient and affix these two components to one another upon installation/assembly. FIG. 5 shows another perspective view of the body 102 of the laser nozzle 100 of FIG. 1 to illustrate some of the alignment and engagement features of the body 102, according to some embodiments of the present invention. FIG. 6 shows a portion of the laser nozzle 100 of FIG. 1 to highlight the alignment and engagement features of FIG. 5, according to some embodiments of the present invention. These features, such as in the form of interferences, steps and/or undercuts, are formed on one or more of the body 102 or the cap 110 prior to assembly for proper alignment and press fitting.

As shown in FIG. 5, the protrusion portion 124 of the body 102 includes a set of axially extending semi-arcuate grooves 502 disposed into the body from the external circumferential surface of protrusion portion 124. The semi-arcuate grooves 502 are arranged circumferentially on the protrusion portion 124 about the central bore 104 (e.g., evenly spaced at regular intervals). Upon engagement between the cap 110 and the body 102, each semi-arcuate groove 502 is adapted to complement an interior surface of the cap 110 to form the lower portion 112b of a secondary passage 112 (as shown in FIG. 1) in support of cutting and cooling during operations of the laser processing system. One advantage of such a configuration is that there is no need to clock any complementary features of the cap 110 with the grooves 502 to form the lower secondary passage portions 112b, thereby enabling ease of assembly (i.e., clockless engagement) between the body 102 and the cap 110.

In some embodiments, each semi-arcuate groove 502 is adjacent to an engagement feature 504 circumferentially disposed on the exterior circumferential surface of the protrusion portion 124 of the body 102. Each engagement feature 504 can be in the form of a step/bump extending from the surface of the protrusion portion 124. Upon engagement of the cap 110 with the body 102, each engagement feature 504 is configured to form a press-fit interface 602 with an interior surface of the cap 102 (as shown in FIG. 6) to prevent the secondary cutting fluid 122 from axially flowing between the cap 110 and the body 102 except via the secondary passages 112 (which are partially defined by the semi-arcuate grooves 502). These engagement features 504 are also adapted to align the body 102 with the cap 110 during engagement.

In some embodiments, the body 102 includes a set of crimping features 506 formed on a circumferential edge 508 of the nozzle body 102 for matingly engaging the cap 110 to the body 102. Each crimping feature 506 can be an undercut, for example. An exemplary interface 604 formed from attaching the cap 110 to the body 102 via these crimping features 504 is illustrated in FIG. 6. In general, undercuts and additional features can be formed into one or both of the body 102 and the cap 110 to allow for alignment and retention (e.g., crimping connections) during manufacture and assembly.

In some embodiments, the body 102 includes the features 140a of the tertiary passages 140 (as described above with reference to FIG. 1), which can comprise a set of grooves circumferentially dispersed around the bore 104. The grooves 140a can be formed into the body 102 from an exterior surface of the body 102. Upon engagement/assembly with the cap 110, these grooves 140a combine with interior surfaces of the cap 110 to form forward-extending channels in the set of tertiary passages 140 that guide the coolant flow 142 toward the distal region 108 of the body 102. One advantage of such a configuration is that there is no need to clock any complementary features of the cap 110 with the grooves to form the forward-extending channels of the tertiary passages 140, thereby enabling ease of assembly (i.e., clockless engagement) between the body 102 and the cap 110.

In some embodiments, surfaces of nozzle body 102, which interact with the laser processing head upon installation into the laser processing system, are shaped with specific angles and shapes to drive contact in specific areas and to insure proper seating and alignment. For example, as shown in FIG. 6, interface 606 between the nozzle body 102 and an adapter 608 connected to the laser processing head (not shown) promotes alignment and contact between these two components.

Furthermore, in addition to the tertiary passage portions 140a, the body 102 can include holes and channels formed circumferentially through and about the body 102 to define a plurality of redirecting coolant channels through and between the body 102 and the cap 110 for thermal regulation during operation.

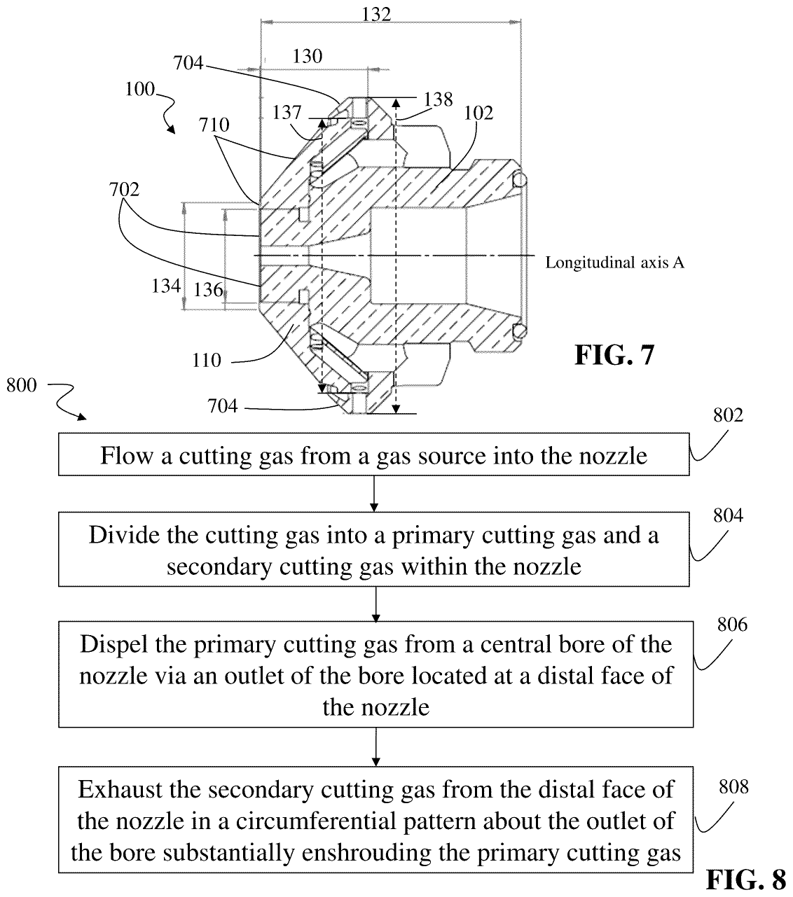

FIG. 7 shows a cross-sectional side view of the laser nozzle 100 of FIG. 1 to illustrate exemplary dimensions of various components of the nozzle 100, according to some embodiments of the present invention. As shown, the cap 110 defines an axial length 130 along the longitudinal axis A and a distal end face width 134 along a direction perpendicular to the longitudinal axis A. The axial length 130 of the cap 110 can be between about 6 mm and about 9 mm, such as 7.9 mm. The distal end face width 134 of the cap 110 can be between about 6 mm and about 9 mm, such as 7.78 mm. Similarly, the body 102 defines an axial length 132 along the longitudinal axis A and a distal end face width 136 along the perpendicular direction. The axial length 132 of the body 102 can be between about 18 mm and about 20 mm, such as 19 mm. The distal end face width 136 of the body 102 can be between about 5 mm and about 7 mm, such as 6.8 mm. In some embodiments, the axial length 130 of the cap 110 is between about 15% and about 35% (e.g., about 25%) of the axial length 132 of the body 102. In some embodiments, the distal end face width 136 of the body 102 is between about 40% and about 60% (e.g., about 50%) of the distal end face width 134 of the cap 110. In some embodiments, cap 110 has a cap width 137 that is less than a total body width 138 of body 102. In addition, body 102 includes a first distal end face 702 directly exposed to the workpiece during operation, first distal end face 702 being disposed across the distal surface of distal end face width 136. Cap 110 includes a second distal end face 710 directly exposed to the workpiece during operation, second distal end face 710 being circumferentially disposed between the edge of distal end face width 136 and cap width 137 and includes a flat section at the distal tip of cap 110 and an angled portion extending proximally back toward body 102. Second distal end face 710 is located circumferentially outward relative the longitudinal axis A and first distal end face 702. Body 102 further includes an outer distal end face 704 directly exposed to the workpiece during operation, outer distal end face 704 being located circumferentially outward relative the longitudinal axis A, first distal end face 702, and second distal end face 710.

FIG. 8 shows an exemplary process 800 for cutting a workpiece with a laser cutting system comprising the laser nozzle 100 of FIG. 1, according to some embodiments of the present invention. The process 800 starts at step 802 with providing a fluid to the nozzle 100, where the fluid can be a cutting gas, such as nitrogen. At step 804, the fluid can be divided into two portions, a primary cutting gas 120 and a secondary cutting gas 122, and provided via two separate paths through the nozzle 100. At step 806, the primary cutting gas 120, along with a laser beam, is provided to the central bore 104 of the nozzle body 102 and dispelled from an exit orifice of the central bore 104 at the distal region 108 of the body 102 to cut the workpiece. At step 808, the secondary cutting gas 122 is provided to the secondary passages 112 cooperatively defined by the nozzle body 102 and nozzle cap 110 and exhausted via outlets 128 from the distal region 108 of the nozzle 100 in a circumferential pattern about the bore 104, substantially enshrouding the primary cutting gas 120 and the laser beam. Due to the smaller cumulative cross-sectional area of the secondary passages 112 in comparison to the cross-sectional area of the narrowest part of the bore 104, the flow rate of the secondary cutting gas 122 is less than the flow rate of the primary cutting gas 120, such as about 50% less.

In some embodiments, the process 800 further includes flowing a cooling gas 142 into the tertiary passages 140 cooperatively defined by the nozzle body 102 and nozzle cap 110 and circumferentially disposed outward from the bore 104 and the secondary passages 112. The cooling gas can be exhausted from a circumferential outlet 144 of the nozzle 100 away from the outlet of the bore 104 for expelling the primary cutting gas 120.

In various embodiments, the cap 110 and the body 102 are separately replaceable components; alternatively, the cap 110 and the body 102 are fixedly joined/assembled. In some embodiments, the body 102 and the cap 110 are made of substantially the same material (e.g., copper). Alternatively, the body 102 and the cap 110 are made of largely different/varied materials. For example, the body 102 can be constructed from copper. As another example, the cap 110 can be made of brass or stainless steel (hard chromed) to improve nozzle/consumable robustness against collisions.

In general, the multi-piece laser cutting nozzle 100, including the body 102 and the distal cap 110, is adapted to ease the manufacturing of complex passages within the nozzle 100 while forming secondary circumferential cutting flow(s) 122 about the primary cutting flow 120. This nozzle 100 is suitable for operation within high-power fiber lasers to cut thick workpieces, such as thick mild steel, with usage of both a primary cutting gas and a secondary gas (e.g., oxygen). Usage of such a nozzle introduces many advantages, including creating a volume of auxiliary cutting gas with a low flow rate (via the auxiliary cutting gas flow paths) that surrounds the cutting kerf, where the low flow rate in the auxiliary cutting gas is adapted to prevent the entrainment of ambient gases into the kerf even at a relatively high standoff distance, and the auxiliary cutting gas does not contribute to the cutting process. Such a nozzle design protects and/or improves the cutting process while permitting a higher cutting standoff distance, which reduces the risk of collisions and increases the laser operating window.

It is understood that various aspects and embodiments of the invention can be combined in various ways. Based on the teachings of this specification, a person of ordinary skill in the art can readily determine how to combine these various embodiments. Modifications may also occur to those skilled in the art upon reading the specification.

What is claimed is:

1. A nozzle for a laser processing head, the nozzle comprising:
a body defining a bore extending between a proximal region of the body and a distal region of the body, the bore configured to conduct a laser beam along with a first portion of a fluid therethrough for delivery to a workpiece;
a cap coupled to the distal region of the body;
a plurality of secondary passages cooperatively defined between the cap and the body and disposed circumferentially about the bore of the body, the plurality of secondary passages are configured to conduct a second portion of the fluid through the distal region and circumferentially about the bore, wherein a flow rate of the second fluid portion through the plurality of secondary passages is slower than a flow rate of the first fluid portion through the bore.

2. The nozzle of claim 1, wherein the plurality of secondary passages includes corresponding ones of a plurality of outlets that are substantially evenly spaced circumferentially about the bore in the distal region.

3. The nozzle of claim 2, wherein each of the plurality of outlets has a non-circular cross-sectional shape.

4. The nozzle of claim 3, wherein the non-circular cross-sectional shape comprises one of arcuate, square, or polygonal.

5. The nozzle of claim 2, wherein the plurality of outlets includes at least four outlets.

6. The nozzle of claim 2, wherein the body includes a protrusion extending from a distal face of the body in the distal region, the protrusion including a distal portion of the bore, and wherein the protrusion is adapted to extend through the cap along a central longitudinal axis of the cap upon the cap being coupled to the body.

7. The nozzle of claim 6, wherein the protrusion is configured to matingly engage the cap to define the plurality of outlets of the secondary passages.

8. The nozzle of claim 6, further comprising a plurality of press fit features formed on a circumferential surface of the protrusion, the plurality of press fit features shaped to engage and align the cap upon the cap being coupled to the body.

9. The nozzle of claim 1, wherein the cap has an axial length of about 25% of an axial length of the body and wherein a distal end face of the body has a width of about 50% of a width of a distal end face of the cap.

10. The nozzle of claim 9, wherein the axial length of the cap is between about 7 mm and about 9 mm.

11. The nozzle of claim 1, wherein the cap is made of brass or stainless steel.

12. The nozzle of claim 1, wherein the first fluid portion through the bore is utilized as a primary cutting gas and the second fluid portion through the plurality of secondary passages is utilized as a secondary cutting gas.

13. The nozzle of claim 1, wherein the bore has a cross-sectional area of between about 1.7 mm² and about 3.1 mm² and the plurality of secondary passages has a combined cross-sectional area of between about 0.7 mm² and about 1.5 mm².

14. The nozzle of claim 13, wherein a ratio of the cross-sectional area of the bore to the combined cross-sectional area of the plurality of secondary passages is between about 1.1 and about 4.4.

15. The nozzle of claim 1, further comprising a plurality of tertiary passages cooperatively defined between the body and the cap and located circumferentially outward from the bore and the plurality of secondary passages, the plurality of tertiary passages configured to direct a coolant flow therethrough.

16. The nozzle of claim 15, wherein the plurality of tertiary passages is configured to direct the coolant flow axially away from the workpiece.

17. The nozzle of claim 1, further comprising at least one sealing feature formed on a proximal surface of the cap and a distal surface of the body proximate the bore.

18. The nozzle of claim 17, wherein the at least one sealing feature comprises a deformable metal seal.

19. The nozzle of claim 1, further comprising a plurality of crimping features formed proximate a circumferential edge of at least one of the cap or the body for matingly engaging the cap to the body.

20. A method for processing a workpiece with a laser cutting system comprising a nozzle, the method comprising:
flowing a cutting gas from a gas source into the nozzle;
dividing the cutting gas into a primary cutting gas and a secondary cutting gas within the nozzle;
dispelling the primary cutting gas from a central bore of the nozzle via an outlet of the bore located at a distal face of the nozzle; and
exhausting the secondary cutting gas from the distal face of the nozzle in a circumferential pattern about the outlet of the bore substantially enshrouding the primary cutting gas.

21. The method of claim 20, wherein the secondary cutting gas has a flow rate of less than about 50% that a flow rate of the primary cutting gas.

22. The method of claim 20, further comprising flowing a cooling gas into a plurality of coolant passages circumferentially disposed about the bore.

23. The method of claim 22, further comprising exhausting the cooling gas from a circumferential surface of the nozzle away from the outlet of the bore for expelling the primary cutting gas.

24. The method of claim 23, wherein the nozzle comprises a body and cap coupled to a distal region of the body, the body and the cap are made from different materials.

25. The method of claim 24, wherein the primary cutting gas substantially flows through the body via the central bore disposed within the body, and wherein the secondary cutting gas substantially flows through a plurality of secondary passages cooperatively defined between the cap and the body and disposed circumferentially about the bore of the body.

26. The method of claim 24, wherein the cooling gas substantially flows through a plurality of tertiary passages cooperatively defined between the body and the cap and located circumferentially outward from the bore and the plurality of secondary passages.

27. The method of claim 24, wherein the nozzle further comprises a plurality of deformable sealing features formed on a proximal surface of the cap and a distal surface of the body proximate the central bore.

28. The method of claim 24, wherein the nozzle further comprises a plurality of crimping features formed proximate a circumferential edge of at least one of the cap or the body for matingly engaging the cap to the body.

29. The method of claim 24, wherein a distal tip of the body comprises a plurality of press fit features shaped to engage and align the cap.
